(19) United States
(12) Patent Application Publication
(10) Pub. No.: US 2021/0367710 A1
(43) Pub. Date: Nov. 25, 2021

(54) APPARATUS AND METHOD FOR SENDING SIDE-CHANNEL BITS ON AN ETHERNET CABLE

(71) Applicant: Intel Corporation, Santa Clara, CA (US)

(72) Inventors: Eric MOUCHEL LA FOSS, Singapore (SG); Biju SUKUMARAN, Singapore (SG); Chee Kiang GOH, Singapore (SG)

(21) Appl. No.: 17/059,499

(22) PCT Filed: Dec. 20, 2018
(86) PCT No.: PCT/US2018/066630

§ 371 Date: Nov. 30, 2020

(51) Int. Cl. H04L 1/00; H04L 29/06

(52) U.S. Cl. CPC H04L 1/0057; H04L 1/0041; H04L 63/0428; H04L 1/0072; H04L 1/0045

(57) ABSTRACT

A method and apparatus for sending side-channel bits on an Ethernet cable. An Ethernet device includes an encoder, a controller, and a signal processor. The encoder may encode payload bits to generate an encoded frame including the payload bits, zero bits, and parity bits. The zero bits are added to the payload bits before encoding. The controller may send side-channel data to the encoder so that the zero bits are replaced with the side-channel bits. The signal processor modulates the encoded frame with the side-channel bits and transmit on an Ethernet cable. The payload bits may be encoded by using low density parity check (LDPC) (1723,2048) code.

### FIELD

Examples relate to a device for communicating over a local area network, more particularly, a method and an apparatus for sending side-channel bits on an Ethernet cable.

### BACKGROUND

Ethernet is one of the most widely used network technologies. Ethernet has been considered as a candidate for an industrial network because of its high bandwidth, cost effectiveness, etc. However, conventional Ethernet is not capable of supporting real-time traffic for the industrial or automotive applications, etc. In order to support those applications, real-time protocols have been developed on top of the Ethernet protocol.

Time sensitive networking (TSN) is a set of standards by the IEEE 802.1 working group. The TSN standards define mechanisms for transmission of time-sensitive data over the Ethernet networks. Current TSN standards provide a mechanism to insert “express packets” inside normal packets within an existing established medium access control (MAC) layer link. IEEE 802.1Qbu provides mechanisms for frame preemption and IEEE 802.3br provides mechanisms for interspersing express traffic (IET). However, the frame preemption schemes defined in 802.1Qbu and 802.3br have a drawback of degrading the throughput of the existing MAC layer data link.

### BRIEF DESCRIPTION OF THE FIGURES

Some examples of apparatuses and/or methods will be described in the following by way of example only, and with reference to the accompanying figures, in which

FIG. 1A is a block diagram of an example apparatus for transmission in accordance with one example;

FIG. 1B is a block diagram of an example apparatus for reception in accordance with one example;

FIG. 2 shows transmission of side-channel bits along with data payload using a zero-bit field in accordance with one example;

FIG. 3 shows a protocol stack for transmitting the side-channel bits along with the payload bits in accordance with one example;

FIG. 4 is a block diagram of a device configured to transmit and/or receive the side-channel data in accordance with one example;

FIG. 5 is a flow diagram of a process of sending low-latency sideband channel data in accordance with one example; and

FIG. 6 is a flow diagram of a process of receiving low-latency sideband channel data in accordance with one example.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

The examples disclosed herein provide a mechanism to transmit and receive low-latency side-channel messages (e.g. control signals) over an Ethernet cable, for example using the IEEE802.3bz standard, without impacting the existing data flow. In examples, the side-channel messages (e.g. low-latency control signals) may be sent as a sideband in the physical layer low density parity check (LDPC) frame going onto the twisted pair Ethernet cable. The MAC layer data link is not impacted with the transmissions of the side-channel messages.

Latency is the time taken to send a unit of data between two points in a network. Low latency signaling allows to send control messages (e.g. information or actuation commands, etc.) with limited time spent between the sender of a message (e.g. the controller in the sending device) and the recipient of the message (e.g. the controller in the receiving device) which are connected by an Ethernet cable. Low latency signaling has gained interest recently in applications like industrial control or automotive networking and is one of the features of TSN. Meeting both low-latency signaling and high data throughput is usually challenging.

In examples disclosed herein, the zero-bits field inserted into an encoded frame in a physical layer may be used to establish a side-band channel for communication of low-latency control signals or messages. The control signal may be sent on the Ethernet cable and processed by the physical layer (PHY). The signaling may be bi-directional so that any device connected on the Ethernet cable may send a side-channel message to the other device(s) connected on the Ethernet cable. There is no need for dedicated cable to transport the low-latency signaling together with a data stream (e.g. a 2.5 Gbps data stream). The control plane and the data plane are separated. In the examples, the MAC layer data payload may not be changed and the MAC layer may continue a high data throughput link without disruption.

The control signals that are sent in accordance with the examples disclosed herein are not easy to analyze via traffic sniffing because is it not correlated to the traffic from the higher Open Systems Interconnection (OSI) layers. It is difficult to decode the control information transmitted in accordance with the examples disclosed herein by snooping.

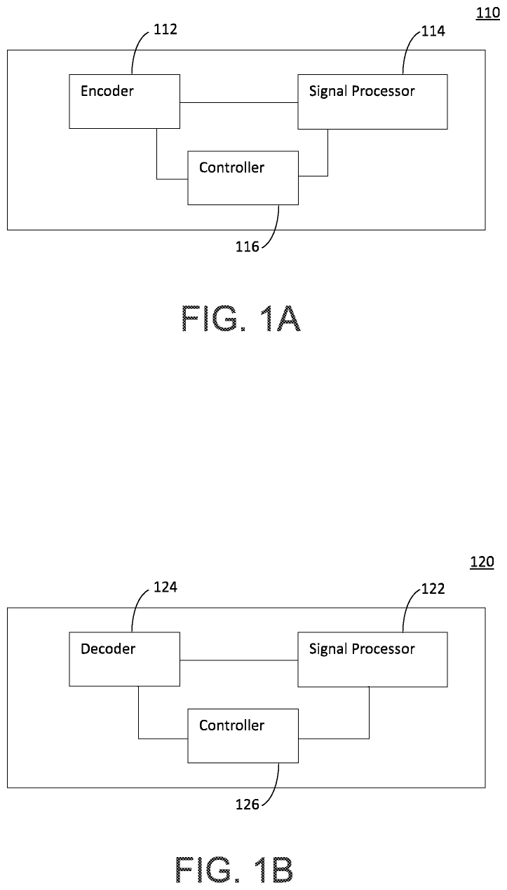

FIG. 1A is a block diagram of an example device 110 for transmitting side-channel bits in accordance with one example. The device 110 includes an encoder 112, a signal processor 114, and a controller 116. The encoder 112 is configured to encode payload bits to be transmitted to a receiving device and generate an encoded frame in accordance with an Ethernet protocol (e.g. IEEE 802.3bz protocol). The encoder 112 may be configured to encode the payload bits using LDPC code. LDPC code is a linear error correcting code. Alternatively, any other channel coding scheme may be used. The encoder 112 may add certain number of zero bits to the payload bits before encoding as defined by IEEE 802.3bz. After encoding, parity bits are added for error correction such that the encoded frame may include the payload bits, the zero bits, and the parity bits. In one example, the encoder may encode the payload bits and the zero bits using LDPC code, for example LDPC (1723,2048) code, which will be explained in detail below.

The controller 116 may be configured to replace the zero bits with side-channel bits. For example, the side-channel bits may be control signals used for equipment control activation in a car or in an industrial robot, or any other control signaling (e.g. urgent control signaling) or sideband data, or the like. The encoded frame is then processed by the signal processor 114 (e.g. digital signal processor and analog signal processor). The encoded frame may be modulated by pulse amplitude modulation (PAM) by the signal processor 114 and then transmitted on an Ethernet cable.

In some examples, the encoder 112 may be configured to encode the side-channel bits for error correction and/or encryption. Any conventional error detection/correction coding and encryption coding may be employed. The side-channel bits may be inserted into the encoded frame at a physical layer.

FIG. 1B is a block diagram of an example device 120 for receiving the side-channel data in accordance with one example. The device 120 includes a signal processor 122, a decoder 124, and a controller 126. The signal processor 122 is configured to receive a signal on an Ethernet cable and demodulate the received signal to generate a received data frame. The received data frame includes payload bits, side-channel bits, and parity bits. The controller 126 is configured to extract the side-channel bits from the received data frame. The controller 126 may be configured to extract the side-channel bits at a physical layer.

The decoder 124 is configured to replace the side-channel bits with zero bits and decode the received data frame to recover the payload bits. The decoder 124 may be configured to decode the received data frame using LDPC code, e.g. LDPC (1723,2048) code. In case the side-channel bits are encoded for error correction and/or encryption, the decoder 124 may be configured to decode the side-channel bits for error correction and/or decryption.

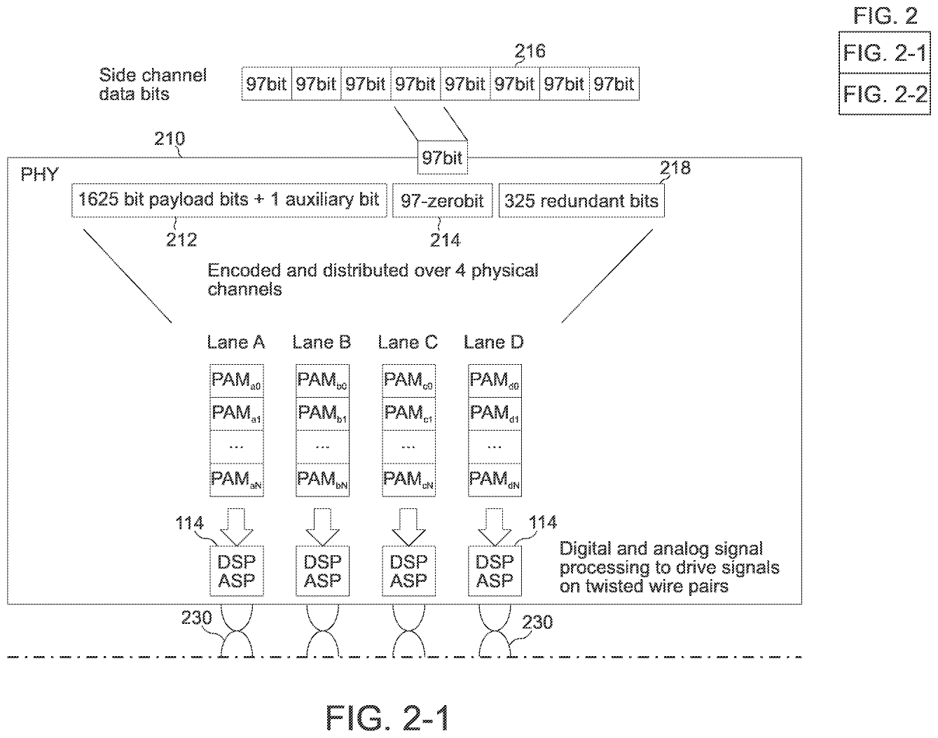

FIG. 2 shows transmission of side-channel bits along with data payload using zero-bit fields in accordance with one example. FIG. 2 shows two Ethernet devices 210, 220 communicating over an Ethernet cable 230 (4 pairs of twisted pair cables). The connection between the Ethernet devices 210, 220 may be bi-directional. Alternatively, the connection between the Ethernet devices 210, 220 may be uni-directional.

In one example, LDPC (1723, 2048) encoding and decoding may be implemented in the transmitting device 210 and the receiving device 220, respectively. LDPC (1723,2048) code is one example of LDPC coding and a different LDPC code or a different channel coding scheme may be implemented as an alternative. The encoder in the transmitting device 210 receives a data stream from a higher layer (e.g. a MAC layer) and may implement a 64b/65b coding, which generates a 65-bit code group from 64-bit data. The 65-bit code groups are then assembled in a group of 50 65-bit blocks. 8 cyclic redundancy check (CRC) check bits are added to generate a data block of (50×65)+8=3,258 bits. A single auxiliary channel bit may be added to obtain a block of 3,259 bits. The 3,259 bits may then be divided into one group of 1,536 bits (3×512) and another block of 1,723 bits. The 1,536 bits may be un-coded, while the 1,723 bits are encoded by the LDPC (1723, 2048) code. The encoder 112 adds 325 LDPC error correction bits 218 (parity bits) to the 1,723 bits to form an LDPC frame of 2,048 coded bits. In combination, the 1,536 un-coded bits (3×512) and the 2,048 coded bits (4×512) may be arranged in a frame of 7×512 bits (512 DSQ symbols). The 7×512 bits may then be distributed over the four (4) physical channels (4 twisted pairs 230). The signal processor 114 (digital signal processor (DSP) and analog signal processor (ASP)) may process and drive signals onto the twisted wire pairs 230.

The IEEE 802.3bz standard defines a 97 zero-bits field to encode payload data 212 of 1,626 bits (including one auxiliary bit) using LDPC (1723,2048) code. The zero bits are added to the payload bits before encoding, and the LDPC (1723,2048) coding is performed on the payload bits and the zero bits.

In examples, at the transmitting device 210, the controller 116 may replace the zero bits 214 with the side-channel bits 216. For example, the side-channel bits may be used for low latency control signaling or any other purposes. The control messages may be variable in length and may be more or less than 97 bits. The side-channel bits 216 may be used for other than control purposes and may simply be data bits. The side-channel bits 216 may be generated in a physical layer or may be originated from any source. The side-channel bits 216 may replace the zero bits 214 in the LDPC frame at the physical layer. The side-channel bits 216 may be encoded for error correction and/or encryption. The encoded LDPC frame including the payload bits 212, the side-channel bits 216, and the parity bits 218 are modulated and transmitted on the four twisted pair cables 230 by the signal processor 114.

In the receiving device 220, the signal processor 122 receives a signal on the twisted pair Ethernet cables 230 and demodulate the signal to the modulation symbols. The modulation symbols are then demodulated and recombined back to LDPC frames. LDPC decoding (e.g. LDPC (1723,2048) decoding) may be performed to recover the payload data 212.

The controller in the receiving device 220 may extract the side-channel bits 216 from the LDPC frame even before decoding the LDPC frame. This will expedite the control signal processing since the LDPC decoding is time consuming and the controller may not wait for completion of the LDPC decoding for obtaining the side-channel bits 216. If the side-channel bits 216 are encoded for error correction and/or encryption at the transmitting device 210, decoding for error correction or decryption may be performed with the side-channel bits 216. Conventionally, in the receiving device 220, the 97 zero-bit positions are discarded and set to zero on a receive path before decoding. In examples disclosed herein, these 97 bit-positions may be used to carry side-channel bits, such as low-latency control signaling, instead of just discarding them.

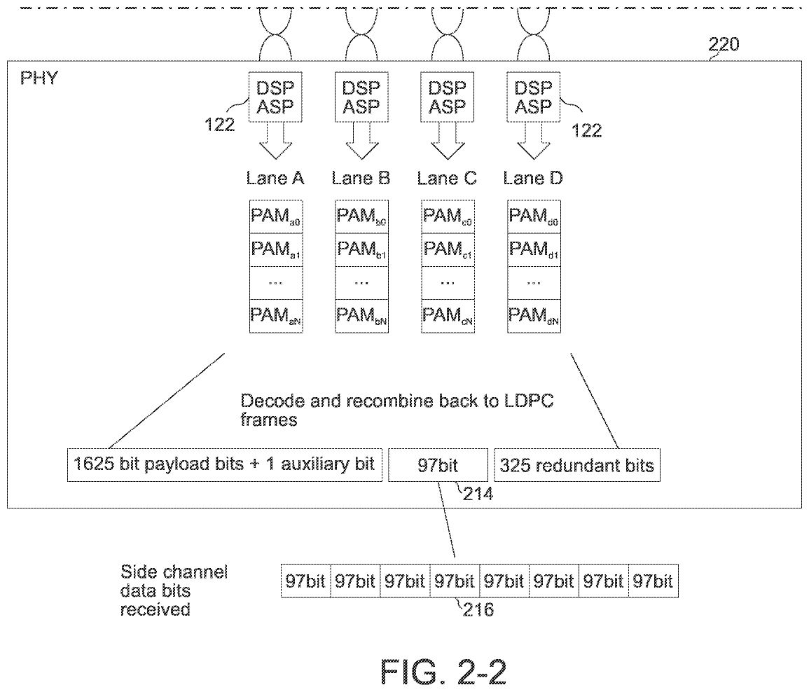

FIG. 3 shows a protocol stack for transmitting the side-channel bits along with the payload bits in accordance with one example. The payload data may be generated at the higher layer (e.g. an application layer, such as a video stream, etc.) and transported via the lower layers of the protocol stack. The data link at the MAC layer may provide a 2.5 Gb/s or 5.0 Gb/s throughput as allowed by the IEEE 802.3bz standard (or different throughput depending on the standards) and may be used to transport high throughput service (e.g. non-compressed video in a car, etc.). The side-channel data (e.g. 97 bits per LDPC frame) may be processed at a physical layer 302 to be carried via the conventional zero-bits field in an LDPC frame as disclosed above without disrupting the MAC data payload. The side-channel data in accordance with the examples do not alter the data throughput because it is carried via the zero bits field, which is discarded at the receiver. The control signaling mechanism in accordance with the examples may support low transmit latency (e.g. about 1 μs) and low receive latency (e.g. about 1.65 μs).

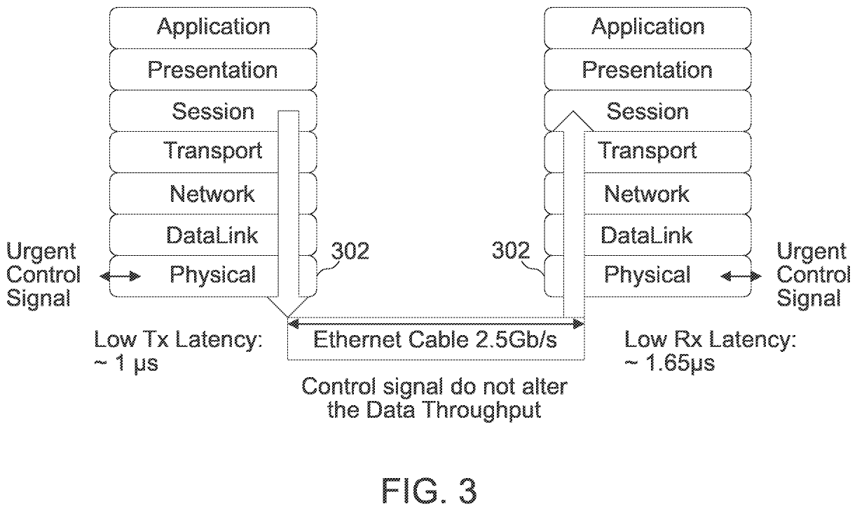

FIG. 4 is a block diagram of a device 400 configured to transmit and/or receive the side-channel data in accordance with one example. The device may be an integrated circuit (IC) chip. The device 400 may be a physical layer chip or may be a part of an integrated chip including additional functionalities other than the physical layer functionalities.

The device 400 may include Ethernet physical layer circuitry 410 and a data interface 420 towards another chip 450 (e.g. system on chip (SoC)) implementing MAC and upper layers. The Ethernet physical layer circuitry 410 may include an ASP 412 for analog signal processing, a DSP 414 for digital signal processing, a physical coding sublayer (PCS) 416 for channel coding/decoding (e.g. an LDPC encoding/decoding). The data interface 420 to the chip 450 implementing MAC and upper layers may include a PCS and serial gigabit media independent interface (SGMII) serdes. The device 400 also includes a controller 430, a management data input/output (MDIO) interface, and an MDIO register(s).

FIG. 4 shows example signal paths of payload data and side-channel data (e.g. control messages, etc.). The payload data (i.e. user data) to be transmitted may be received from the chip 450 implementing MAC and upper layers and processed by the Ethernet physical layer circuitry 410 and then transmitted on to the Ethernet cable 460. For transmission of side-channel data, the side-channel data may be received by the controller 430 via the MDIO interface 434 and may be temporarily stored in the MDIO register 432. The controller 430 sends the side-channel data to the PCS 416 to be replaced with the zero bits in the LDPC frame as explained above. For reception of side-channel data, the controller 430 may extract the side-channel data from the received LDPC frame as explained above and sends the side-channel data via the MDIO interface 434.

The device 400 may also include circuitry for clock management, universal asynchronous receiver/transceiver interface, light emitting diode (LED) control, general purpose input/output (GPIO) interface, serial parallel interface (SPI), direct current to direct current (DC-DC) conversion, etc.

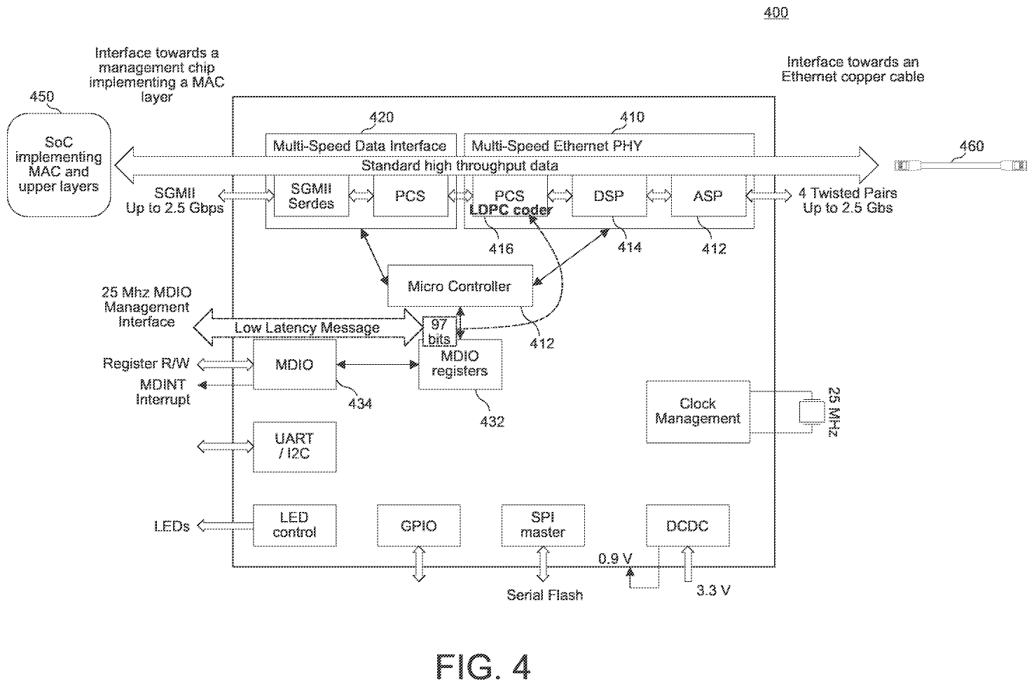

FIG. 5 is a flow diagram of a process of sending low-latency side-channel data in accordance with one example. A transmitting device may receive payload bits to be transmitted, add zero bits to the payload bits, and then encode the payload bits and the zero bits to generate an encoded frame including the payload bits, the zero-bits, and parity bits (502). The payload bits may be encoded with an LDPC (1723,2048) code. The transmitting device may replace the zero-bits with side-channel bits (504). The transmitting device may then modulate the encoded frame with the side-channel bits and transmit the modulated encoded frame on an Ethernet cable (506). The transmitting device may encode the side-channel bits 216 for error correction and/or encryption.

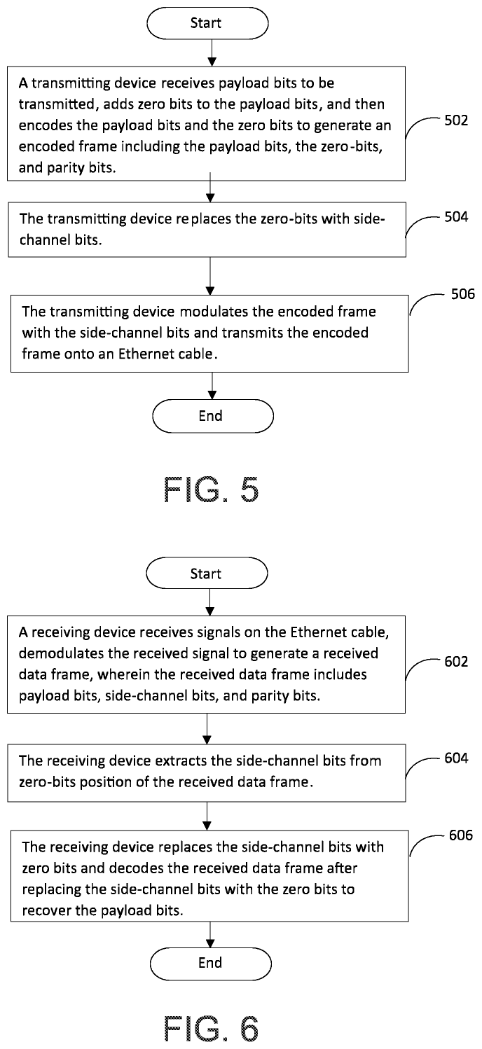

FIG. 6 is a flow diagram of a process of receiving low-latency side-channel data in accordance with one example. A receiving device may receive a signal on the Ethernet cable, and demodulate the received signal to generate a received data frame (602). The received data frame includes payload bits, side-channel bits, and parity bits. The receiving device may extract the side-channel bits from zero-bits position of the received data frame (604). The receiving device may replace the side-channel bits with zero bits and decode the received data frame after replacing the side-channel bits with the zero bits to recover the payload bits (606). LDPC decoding (e.g. LDPC (1723,2048) code) may be used to recover the payload data 212. If the side-channel bits 216 are encoded for error correction and/or encryption, the receiving device may decode the side-channel bits 216.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:

Example 1 is a device for sending side-channel bits on an Ethernet cable. The device includes an encoder configured to encode payload bits to generate an encoded frame, wherein zero bits are added to the payload bits before encoding to generate parity bits, a controller configured to replace the zero bits with the side-channel bits, and a signal processor configured to modulate the encoded frame with the side-channel bits and transmit the modulated encoded frame on an Ethernet cable.

Example 2 is the device of example 1, wherein the encoder is configured to encode the payload bits and the zero bits using an LDPC (1723,2048) code.

Example 3 is the device as in any one of examples 1-2, wherein the encoder is configured to encode the side-channel bits for error correction and/or encryption.

Example 4 is the device as in any one of examples 1-3, wherein the zero bits are replaced with the side-channel bits at a physical layer.

Example 5 is the device as in any one of examples 1-4, wherein the side-channel bits are used for control signals.

Example 6 is a device for receiving side-channel data on an Ethernet cable. The device includes a signal processor configured to receive a signal on an Ethernet cable and demodulate the received signal to generate a received data frame, wherein the received data frame includes payload bits, side-channel data bits, and parity bits, a controller configured to extract the side-channel bits from zero-bits positions of the received data frame, and a decoder configured to replace the side-channel bits with zero bits and decode the received data frame to recover the payload bits.

Example 7 is the device of example 6, wherein the decoder is configured to decode the received data frame using an LDPC (1723,2048) code.

Example 8 is the device as in any one of examples 6-7, wherein the decoder is configured to decode the side-channel bits for error correction and/or decryption.

Example 9 is the device as in any one of examples 6-8, wherein the controller is configured to extract the side-channel bits at a physical layer.

Example 10 is the device as in any one of examples 6-9, wherein the side-channel bits are used for control signals.

Example 11 is a method of sending side-channel data on an Ethernet cable. The method includes receiving payload bits to be transmitted, adding zero bits to the payload bits, encoding the payload bits and the zero bits to generate an encoded frame including the payload bits, the zero-bits, and parity bits, replacing the zero-bits with side-channel bits, modulating the encoded frame with the side-channel bits, and transmitting the modulated encoded frame on an Ethernet cable.

Example 12 is the method of example 11, wherein the payload bits are encoded by using an LDPC (1723,2048) code.

Example 13 is the method as in any one of examples 11-12, further including encoding the side-channel bits for error correction and/or encryption.

Example 14 is the method as in any one of examples 11-13, wherein the zero bits are replaced with the side-channel bits at a physical layer.

Example 15 is a method of receiving side-channel data on an Ethernet cable. The method includes receiving a signal on the Ethernet cable, demodulating the received signal to generate a received data frame, wherein the received data frame includes payload bits, side-channel bits, and parity bits, extracting the side-channel bits from zero-bits positions of the received data frame, replacing the side-channel bits with zero bits, and decoding the received data frame after replacing the side-channel bits with the zero bits to recover the payload bits.

Example 16 is a computer program having a program code for performing a method as in any one of examples 11-15.

Example 17 is a machine-readable storage including machine readable instructions, when executed, to implement a method or realize an apparatus as in any one of examples 1-16.

Example 18 is a machine-readable medium including code, when executed, to cause a machine to perform a method as in any one of examples 11-15.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A device for sending side-channel bits on an Ethernet cable, comprising:
an encoder configured to encode payload bits to generate an encoded frame, wherein zero bits are added to the payload bits before encoding to generate parity bits,
a controller configured to replace the zero bits with the side-channel bits, and
a signal processor configured to modulate the encoded frame with the side-channel bits and transmit the modulated encoded frame on an Ethernet cable.

2. The device of claim 1, wherein the encoder is configured to encode the payload bits and the zero bits using a low density parity check (LDPC) code.

3. The device of claim 1, wherein the encoder is configured to encode the side-channel bits for error correction and/or encryption.

4. The device of claim 1, wherein the zero bits are replaced with the side-channel bits at a physical layer.

5. The device of claim 1, wherein the side-channel bits are used for control signals.

6. A device for receiving side-channel data on an Ethernet cable, comprising:
a signal processor configured to receive a signal on an Ethernet cable and demodulate the received signal to generate a received data frame, wherein the received data frame includes payload bits, side-channel data bits, and parity bits,
a controller configured to extract the side-channel bits from zero-bits positions of the received data frame, and
a decoder configured to replace the side-channel bits with zero bits and decode the received data frame to recover the payload bits.

7. The device of claim 6, wherein the decoder is configured to decode the received data frame using a low density parity check (LDPC) code.

8. The device of claim 6, wherein the decoder is configured to decode the side-channel bits for error correction and/or decryption.

9. The device of claim 6, wherein the controller is configured to extract the side-channel bits at a physical layer.

10. The device of claim 6, wherein the side-channel bits are used for control signals.

11. A method of sending side-channel data on an Ethernet cable, comprising:
receiving payload bits to be transmitted,
adding zero bits to the payload bits,
encoding the payload bits and the zero bits to generate an encoded frame including the payload bits, the zero-bits, and parity bits,
replacing the zero-bits with side-channel bits,
modulating the encoded frame with the side-channel bits, and
transmitting the modulated encoded frame on an Ethernet cable.

12. The method of claim 11, wherein the payload bits are encoded by using a low density parity check (LDPC) code.

13. The method of claim 11, further comprising: encoding the side-channel bits for error correction and/or encryption.

14. The method of claim 11, wherein the zero bits are replaced with the side-channel bits at a physical layer.

15. A method of receiving side-channel data on an Ethernet cable, comprising:
receiving a signal on the Ethernet cable,
demodulating the received signal to generate a received data frame, wherein
the received data frame includes payload bits, side-channel bits, and parity bits,
extracting the side-channel bits from zero-bits positions of the received data frame,
replacing the side-channel bits with zero bits, and
decoding the received data frame after replacing the side-channel bits with the zero bits to recover the payload bits.
